(19) United States
(12) Patent Application Publication
(10) Pub. No.: US 2023/0196059 A1
(43) Pub. Date: Jun. 22, 2023

(54) ATTENTION-BASED BRAIN EMULATION NEURAL NETWORKS

(71) Applicant: X Development LLC, Mountain View, CA (US)

(72) Inventors: Sarah Ann Laszlo, Mountain View, CA (US); Lam Thanh Nguyen, Mountain View, CA (US); Baihan Lin, New York, NY (US); Julia Renee Watson, Toronto (CA); Garrett Raymond Honke, Mountain View, CA (US)

(21) Appl. No.: 17/557,618

(22) Filed: Dec. 21, 2021

(51) Int. Cl. G06N 3/00

(52) U.S. Cl. CPC G06N 3/008

(57) ABSTRACT

In one aspect, there is provided a method performed by one or more data processing apparatus, the method includes: obtaining a network input including a respective data element at each input position in a sequence of input positions, and processing the network input using a neural network to generate a network output that defines a prediction related to the network input, where the neural network includes a sequence of encoder blocks and a decoder block, where each encoder block has a respective set of encoder block parameters, and where the set of encoder block parameters includes multiple brain emulation parameters that, when initialized, represent biological connectivity between multiple biological neuronal elements in a brain of a biological organism.

### BACKGROUND

This specification relates to processing data using machine learning models. Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a method implemented as computer programs on one or more computers in one or more locations for processing a neural network input, using a neural network that includes a sequence of encoder blocks, to generate a neural network output that defines a prediction related to the network input.

Throughout this specification, a “synaptic connectivity graph” can refer to a graph that represents a biological connectivity between neuronal elements in a brain of a biological organism. A “neuronal element” can refer to an individual neuron, a portion of a neuron, a group of neurons, or any other appropriate biological neuronal element, in the brain of the biological organism. The synaptic connectivity graph can include multiple nodes and edges, where each edge connects a respective pair of nodes. A “sub-graph” of the synaptic connectivity graph can refer to a graph specified by: (i) a proper subset of the nodes of the synaptic connectivity graph, and (ii) a proper subset of the edges of the synaptic connectivity graph.

For convenience, throughout this specification, a neural network having one or more neural network layers having parameters that, when initialized, represent a synaptic connectivity graph, or a sub-graph of the synaptic connectivity graph, can be referred to as a “brain emulation” neural network. A set of parameters of a neural network that, when initialized, represent biological connectivity in the brain of a biological organism can be referred to as “brain emulation parameters.” Identifying an artificial neural network as a “brain emulation” neural network is intended only to conveniently distinguish such neural networks from other neural networks (e.g., with entirely hand-engineered architectures), and should not be interpreted as limiting the nature of the operations that may be performed by the neural network or otherwise implicitly characterizing the neural network.

An “attention-based brain emulation neural network” can refer to a neural network that includes one or more neural network layers having an architecture that is at least partially specified by the synaptic connectivity graph, and that is configured to perform an attention operation, e.g., an operation that relates different input positions in a single sequence of input positions to generate a representation of the sequence.

According to a first aspect, there is provided a method performed by one or more data processing apparatus, the method includes: obtaining a network input including a respective data element at each input position in a sequence of input positions, and processing the network input using a neural network to generate a network output that defines a prediction related to the network input. The neural network includes a sequence of encoder blocks and a decoder block.

Each encoder block has a respective set of encoder block parameters and performs operations including: receiving a respective current embedding for each input position, processing the current embeddings for the input positions, in accordance with the set of encoder block parameters, to update the respective current embedding for each input position, including applying an attention operation to the current embeddings for the input positions. The set of encoder block parameters includes multiple brain emulation parameters that, when initialized, represent biological connectivity between multiple biological neuronal elements in a brain of a biological organism.

The decoder block has a set of decoder block parameters and performs operations including: receiving the respective current embedding for each input position from a final encoder block in the sequence of encoder blocks, and processing the current embeddings for the input positions, in accordance with the set of decoder block parameters, to generate the network output.

In some implementations, at least one encoder block in the sequence of encoder blocks includes a feed forward module, and where the feed forward module includes one or more brain emulation neural network layers having multiple brain emulation parameters that, when initialized, represent biological connectivity between multiple biological neuronal elements in the brain of the biological organism.

In some implementations, the feed forward module is configured to: for each input position in the sequence of input positions: receive an input at the input position, and apply a sequence of transformations to the input at the input position using the one or more brain emulation neural network layers to generate an output for the input position.

In some implementations, at least one encoder block in the sequence of encoder blocks includes an attention module that includes: (i) a query sub-network configured to process the respective current embedding for each input position to generate a query vector, (ii) a key sub-network configured to process the respective current embedding for each input position to generate a key vector, and (iii) a value sub-network configured to process the respective current embedding for each input position to generate a value vector.

In some implementations, the query sub-network, the key sub-network, and the value sub-network, each include one or more brain emulation neural network layers having multiple brain emulation parameters that, when initialized, represent biological connectivity between multiple biological neuronal elements in the brain of the biological organism.

In some implementations, the attention module is configured to perform the attention operation, where the attention operation includes, for each input position in the sequence of input positions: processing the respective current embedding for the input position using the one or more brain emulation neural network layers included in the query sub-network to generate a query vector, processing the respective current embedding for the input position using the one or more brain emulation neural network layers included in the key sub-network to generate a key vector, processing the respective current embedding for the input position using the one or more brain emulation neural network layers included in the value sub-network to generate a value vector, determining a respective input-position specific weight for each of the input positions by applying a compatibility function between the query vector for the input position and the key vectors, and determining the updated current embedding for the input position by determining a weighted sum of the value vectors weighted by the corresponding input-position specific weights for the input positions.

In some implementations, the set of decoder block parameters includes multiple brain emulation parameters that, when initialized, represent biological connectivity between multiple biological neuronal elements in the brain of the biological organism.

In some implementations, a data type of the network input includes an image data type, a text data type, or an audio data type.

In some implementations, multiple brain emulation parameters are determined from a synaptic connectivity graph that represents biological connectivity between multiple biological neuronal elements in the brain of the biological organism.

In some implementations, the synaptic connectivity graph includes multiple nodes and edges, each edge connects a pair of nodes, each node corresponds to a respective neuronal element in the brain of the biological organism, and each edge connecting a pair of nodes in the synaptic connectivity graph corresponds to a biological connection between a pair of biological neuronal elements in the brain of the biological organism.

In some implementations, multiple brain emulation parameters are held static during training of the neural network.

In some implementations, multiple brain emulation parameters are determined prior to training of the neural network based on weight values associated with biological connections between multiple biological neuronal elements in the brain of the biological organism.

In some implementations, multiple brain emulation parameters are determined from a synaptic resolution image of at least a portion of the brain of the biological organism, the determining including: processing the synaptic resolution image to identify: (i) multiple biological neuronal elements, and (ii) multiple biological connections between pairs of biological neuronal elements, determining a respective value of each brain emulation parameter, including: setting a value of each brain emulation parameter that corresponds to a pair of biological neuronal elements in the brain that are not connected by a biological connection to zero, and setting a value of each brain emulation parameter that corresponds to a pair of biological neuronal elements in the brain that are connected by a biological connection based on a proximity of the pair of biological neuronal elements in the brain.

In some implementations, each biological neuronal element of multiple biological neuronal elements is a biological neuron, a part of a biological neuron, or a group of biological neurons.

In some implementations, multiple brain emulation parameters are arranged in a two-dimensional weight matrix having multiple rows and multiple columns, where each row and each column of the weight matrix corresponds to a respective biological neuronal element from multiple biological neuronal elements, and where each brain emulation parameter in the weight matrix corresponds to a respective pair of biological neuronal elements in the brain of the biological organism, the pair including: (i) the biological neuronal element corresponding to a row of the brain emulation parameter in the weight matrix, and (ii) the biological neuronal element corresponding to a column of the brain emulation parameter in the weight matrix.

In some implementations, initializing multiple brain emulation parameters includes performing a matrix multiplication of: (i) the two-dimensional weight matrix of brain emulation parameters representing synaptic connectivity between the plurality of biological neuronal elements in the brain of the biological organism, and (ii) the current embeddings for the input positions.

In some implementations, each brain emulation parameter of the weight matrix has a respective value that characterizes synaptic connectivity in the brain of the biological organism between the respective pair of biological neuronal elements corresponding to the brain emulation parameter.

In some implementations, each brain emulation parameter of the weight matrix that corresponds to a respective pair of biological neuronal elements that are not connected by a biological connection in the brain of the biological organism has value zero, and each brain emulation parameter of the weight matrix that corresponds to a respective pair of biological neuronal elements that are connected by a biological connection in the brain of the biological organism has a respective non-zero value characterizing an estimated strength of the biological connection.

According to a second aspect, there is provided a system that includes one or more computers, and one or more storage devices communicatively coupled to the one or more computers, where the one or more storage devices store instructions that, when executed by the one or more computers, cause the one or more computers to perform operations of any preceding aspect.

According to a third aspect, there are provided one or more non-transitory computer storage media storing instructions that when executed by one or more computers cause the one or more computers to perform operations of any preceding aspect.

Particular embodiments of the subject matter described in this specification can be implemented so as to realize one or more of the following advantages.

The method described in this specification can process a neural network input, using an attention-based brain emulation neural network, to generate a neural network output that defines a prediction for the network input. The attention-based brain emulation neural network can include brain emulation parameters that, when initialized, can represent biological connectivity between biological neuronal elements in the brain of a biological organism. The brains of biological organisms may be adapted by evolutionary pressures to be effective at solving certain tasks, e.g., classifying obj ects or generating robust obj ect representations, and attention-based brain emulation neural networks may therefore share this capacity to effectively solve tasks. In particular, compared to other attention-based neural networks, e.g., with manually specified neural network architectures and parameters, attention-based brain emulation neural networks may require less training data, fewer training iterations, or both, to perform attention operations and solve certain tasks. Moreover, attention-based brain emulation neural networks may perform certain machine learning tasks more effectively, e.g., with higher accuracy, than other neural networks.

For example, in contrast to many conventional computer vision techniques, a biological brain may process visual data to generate a robust representation of the visual data that may be insensitive to factors such as the orientation and size of elements (e.g., objects) characterized by the visual data. The attention-based brain emulation neural network may also be effective at solving these (and other) tasks as a result of having brain emulation parameters that are derived from the biological brain. Because the attention-based brain emulation neural network can be more effective at performing certain machine learning tasks, the amount of training data and the number of training iterations required to train the neural network can be significantly fewer when compared to other, e.g., hand-engineered, attention-based neural networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network computing system that includes an attention-based brain emulation neural network.

FIG. 2 is a block diagram of an example encoder block included in an attention-based brain emulation neural network.

FIG. 3 is a block diagram that shows an example encoder block in more detail.

FIG. 4 is a flow diagram of an example process for processing a network input using an attention-based brain emulation neural network.

FIG. 5 is an example data flow for generating a brain emulation neural network architecture using a synaptic connectivity graph.

FIG. 6 is a block diagram of an example architecture mapping system.

FIG. 7 illustrates an example adjacency matrix and an example weight matrix of a brain emulation neural network layer determined using a synaptic connectivity graph.

FIG. 8 is an example data flow for generating a synaptic connectivity graph based on the brain of a biological organism.

FIG. 9 is a block diagram of an example computer system.

Like reference numbers and designations in the various drawings indicate like elements.

### DETAILED DESCRIPTION

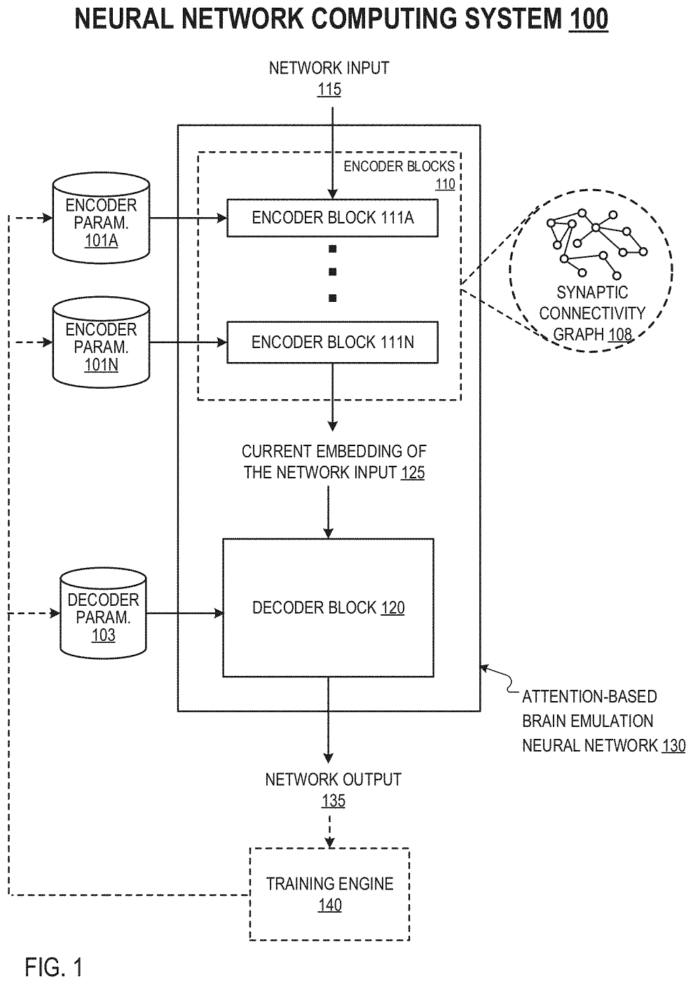

FIG. 1 is a block diagram of an example neural network computing system 100 that includes an attention-based brain emulation neural network 130. The neural network computing system 100 is an example of a system implemented as computer programs on one or more computers in one or more locations in which the systems, components, and techniques described below are implemented.

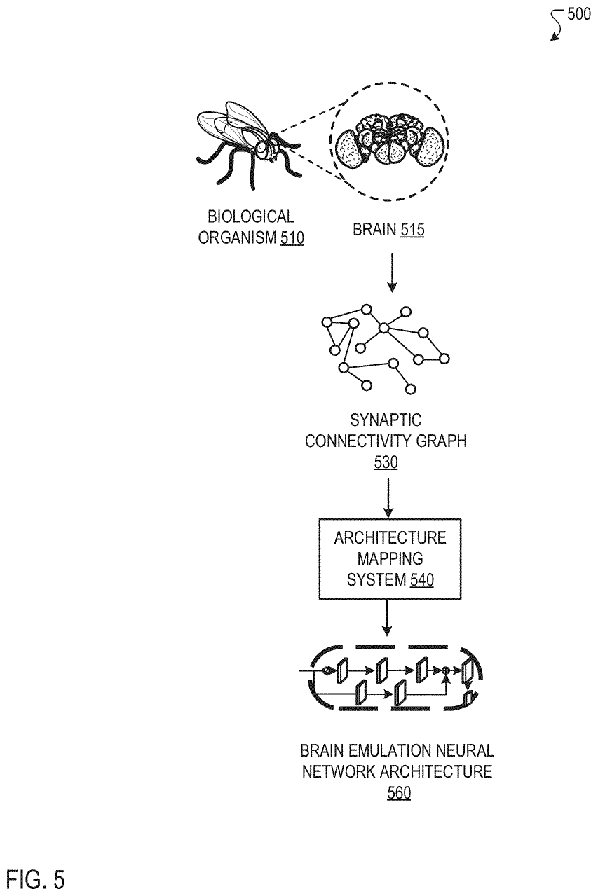

As will be described in more detail below, the attention-based brain emulation neural network 130 can include a sequence of encoder blocks 110 (e.g., 1, 10, 50, 100, etc. encoder blocks) and at least one decoder block 120. In some implementations, the neural network 130 can include only one or more encoder blocks 110. In some implementations, the neural network 130 can include only one or more decoder blocks 120. Some, or all, of the encoder blocks 110, and/or the decoder block 120, can include one or more brain emulation neural network layers. Generally, throughout this specification, a “brain emulation neural network layer” can refer to a neural network layer having brain emulation parameters that, when initialized, represent a synaptic connectivity graph 108. As will be described in more detail below with reference to FIG. 5, the synaptic connectivity graph 108 can represent connectivity between biological neuronal elements in the brain of a biological organism. As used throughout this document, the “brain” can refer to any amount of nervous tissue from a nervous system of the biological organism, and nervous tissue can refer to any tissue that includes neurons (i.e., nerve cells). The biological organism can be, e.g., a fly, a fish, a worm, a cat, a mouse, or a human.

A “neuronal element” can refer to an individual neuron, a portion of a neuron, a group of neurons, or any other appropriate biological element in the brain of the biological organism. The synaptic connectivity graph 108 can include multiple nodes and multiple edges, where each edge connects a respective pair of nodes. In one example, each node in the synaptic connectivity graph 108 can represent an individual neuron, and each edge connecting a pair of nodes in the graph 108, can represent a respective synaptic connection between the corresponding pair of individual neurons.

In some implementations, the synaptic connectivity graph 108 can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph 108 can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph 108 can include features of both the “over-segmented” graph and the “contracted” graph. Generally, the synaptic connectivity graph 108 can include nodes and edges that represent any appropriate neuronal element, and any appropriate connection between a pair of neuronal elements, respectively, in the bran of the biological organism. The components of the attention-based brain emulation neural network 130 will be described in more detail next.

The attention-based brain emulation neural network 130 can receive a network input 115, and process the network input 115 to generate a network output 135 that defines a prediction for the network input 115. In some implementations, the network input 115 can include, e.g., a sequence of input positions, each input position including a respective data element. The input positions in the sequence can be arranged in an input order. For example, the network input 115 can be a sequence of words, and each data element can correspond to a word in the sequence of words. Similarly, in some implementations, the network output 135 can include a sequence of output positions, each output position including a respective data element. The output positions in the sequence can be arranged in an output order. For example, the network output 135 can be a sequence of words, and each data element can correspond to a word in the sequence of words.

As a particular example, the network input 115 can be a sequence of words in an original language (e.g., English), and the network output 135 can be a translation of the input sequence into a target language (e.g., French), e.g., a sequence of words in the target language that represents the sequence of words in the original language. However, in some implementations, the network output 135 does not include a sequence of output positions, and generally represents any appropriate prediction for the network input 115.

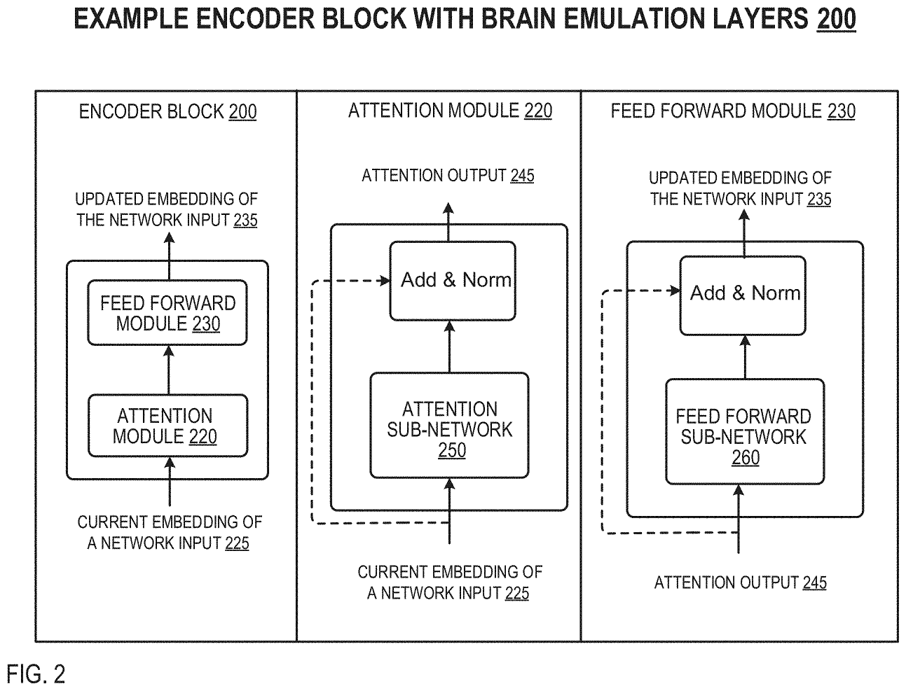

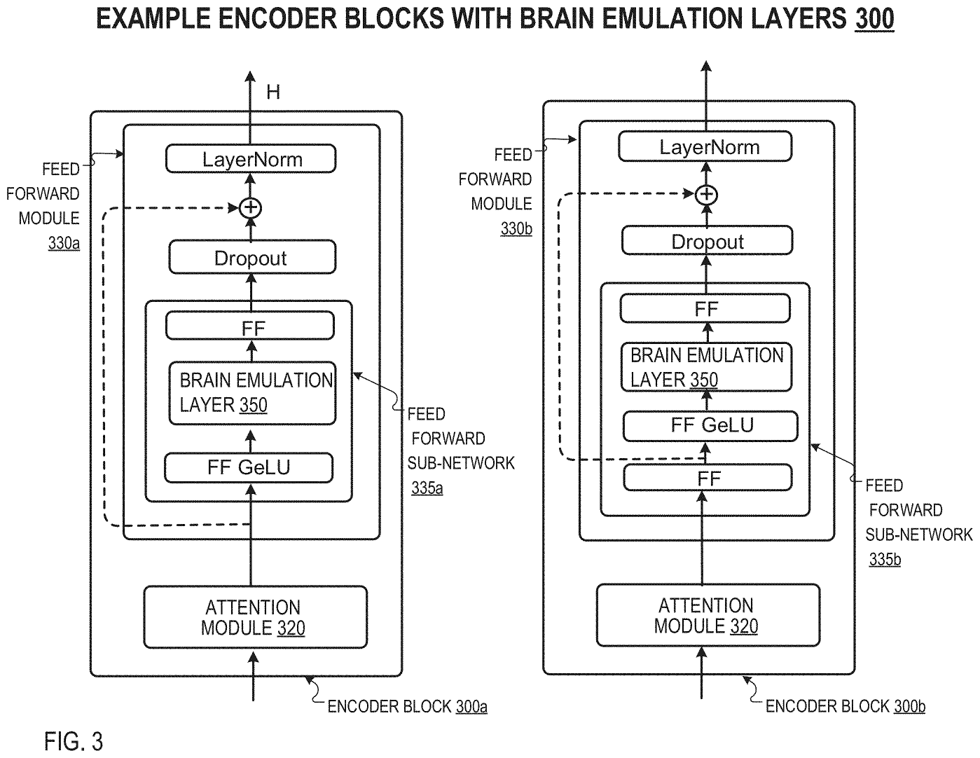

The attention-based brain emulation neural network 130 can be configured to perform an attention operation. Generally, an “attention operation” can refer to, e.g., an operation that relates different input positions in a single sequence of input positions to generate a representation of the sequence. Example attention operations that can be performed by the attention-based brain emulation neural network 130 will be described in more detail below with reference to FIG. 2 and FIG. 3.

As described above, the attention-based neural network 130 can include (i) one or more encoder blocks 110, and (ii) a decoder block 120. Each of the encoder blocks 110 can have a respective set of encoder block parameters, e.g., a first encoder block 111A can have encoder block parameters 101A, and a second encoder block 111N can have encoder block parameters 101N. Similarly, the decoder block 120 can have a set of decoder block parameters, e.g., the decoder block 120 can have decoder block parameters 103.

The attention-based brain emulation neural network 130 can generally include any number of encoder blocks 110 and/or decoder blocks 120. The encoder blocks 110 and/or decoder blocks 120 can be arranged in a sequence, e.g., the output from a first encoder block in the sequence of encoder blocks can be provided as an input to a second encoder block in the sequence of encoder blocks, where the first encoder block and the second encoder block are neighboring blocks in the sequence.

The attention-based brain emulation neural network 130 can include an embedding neural network layer that is configured to process the network input 115 and map each data element at each input position in the sequence of input positions to a corresponding embedding. In other words, the embedding layer can process the network input 115 to generate an embedding of the network input 115. In some implementations, the embedding layer can generate the embedding by mapping each input data element to a respective one-hot vector, or any other appropriate vector, representing the data element.

In some implementations, the embedding layer can generate an embedding for each input position in the sequence of input positions and then combine, e.g., sum or average, the embedded representation of the network input with a positional embedding of the network input's position in the input sequence. Such positional embeddings can enable the attention-based brain emulation neural network to make full use of the order of the input sequence without relying on recurrence or convolutions. The embedding layer can provide the embedding of the network input (e.g., a combination of the embedding of the network input and the positional embedding of the network input, for each input position in the sequence of input positions) as an input to the first encoder block in the sequence (e.g., encoder block 111A).

The first encoder block 111A can be configured to process the embedding of the network input 115 (e.g., received from the embedding layer), in accordance with the set of the encoder block parameters 101A, and update the embedding of the network input 115. More specifically, the first encoder block 111A can process the embedding of each data element at each respective input position in the sequence of input positions and update the embedding of each of the data elements for each of the input positions. An “embedding” generally refers to, e.g., an ordered collection of numerical values such as, e.g., a vector or a matrix of numerical values. The first encoder block 111A can provide the updated embedding of the network input 115 to the next encoder block in the sequence of encoder blocks as an input.

The next encoder block in the sequence can process the embedding of the network input 115 (e.g., received from the first encoder block 111A), in accordance with the respective set of encoder block parameters, to update the embedding of the network input 115. More specifically, the next encoder block can process the embedding of each data element at each respective input position in the sequence of input positions and update the embedding of each data element at each respective input position in the sequence of input positions. In other words, each encoder block 110 in the sequence of encoder blocks can update the embedding of the network input 115, in accordance with the respective set of encoder block parameters, received from the previous encoder block in the sequence.

The last encoder block in the sequence (e.g., the encoder block 111N in this example) can receive the embedding of the network input 115 from the previous encoder block in the sequence, and update the embedding of the network input 115, in accordance with the set of encoder block parameters 101N, to generate an output that represents the current embedding of the network input 125.

The decoder block 120 can receive the current embedding of the network input 125 from the last encoder block 111N, and process the current embedding of the network input 125, in accordance with the set of decoder block parameters 103, to generate the network output 135 that defines the prediction related to the network input 115. More specifically, the decoder block 120 can receive from the encoder block 111N the respective current embedding for each input position in the sequence of input positions and process the current embeddings for the input positions to generate the network output 135. As described above, in some implementations, the network output 135 can include a sequence of output positions and a respective data element at each of the output positions in the sequence of output positions.

In some implementations, the decoder block 120 can pool (e.g., by max pooling or average pooling) the embeddings, generated by the last encoder block in the sequence of encoder blocks (e.g., the encoder block 111N), to generate a combined embedding. The decoder block 120 can process the combined embedding using one or more neural network layers to generate the network output 135. In some implementations, the decoder block 120 can generate the network output 135 in an autoregressive manner.

For example, the decoder block 120 can generate an output for a particular output position in a sequence of output positions by generating, at each of multiple generation time steps, the output for the output position conditioned on (i) the embeddings for the sequence of input positions, and (ii) the outputs for each output position in the sequence of output positions preceding the particular output position. In other words, at each of multiple generation time steps, the decoder block 120 can process: (i) the embeddings generated by the final encoder block in the sequence of encoder blocks, and (ii) output data elements generated at any preceding time step, to generate an output data element for the current generation time step.

Each component of the system 100 can have any appropriate neural network architecture that enables it to perform its described function, e.g., can include fully-connected layers, convolutional layers, attention layers, or any other appropriate neural network layers. In some implementations, some, or all, components of the system 100 do not include any recurrent or convolutional neural network layers, and instead include multiple attention layers, or sub-networks, that are configured to perform the attention operation, as will be described in more detail below with reference to FIGS. 2 and 3.

As described above, the attention-based brain emulation neural network 130 can further include one or more brain emulation neural network layers having an architecture that is specified by the synaptic connectivity graph 108 that represent synaptic connectivity between biological neuronal elements in the brain of the biological organism. In some implementations, as will be described in more detail below with reference to FIGS. 2 and 3, one or more brain emulation neural network layers can be included in some, or all, of the encoder blocks 110, and/or in the decoder block 120. Accordingly, the set of parameters of some, or all, of the encoder blocks 110, and/or the decoder block, can additionally include brain emulation parameters that can be used by the respective components of the system 100 to process an input and generate an output.

Generally, some, or all, of the encoder blocks 110, and/or the decoder block 120, can include different brain emulation layers, e.g., neural network layers having brain emulation parameters that, when initialized, represent different sub-graphs of the synaptic connectivity graph 108. By way of example, a first encoder block in the sequence of encoder blocks can include brain emulation layers that represent, e.g., visual processing region of the brain of the biological organism, while a second encoder block in the sequence of encoder blocks can include brain emulation layers that represent, e.g., audio processing region of the brain of the biological organism.

Furthermore, in some implementations, some, or all, of the encoder blocks 110, and/or the decoder block 120, can include brain emulation layers having brain emulation parameters that, when initialized, represent different synaptic connectivity graphs 108, e.g., the brain of different biological organisms. By way of example, the first encoder block can include brain emulation layers that represent, e.g., the brain of a fly, while the second encoder block can include brain emulation layers that represent, e.g., the brain of a cat. The attention-based brain emulation neural network 130 can generally include any number and configuration of brain emulation neural network layers having brain emulation parameters that, when initialized, represent the brain of any number and type of biological organisms.

For example, the encoder block 111A can include one or more brain emulation neural network layers, the encoder block parameters 101A can include brain emulation parameters, and the encoder block 111A can use the encoder block parameters 101A to process the network input 115 to generate an embedding of the network input 115, e.g., as described above.

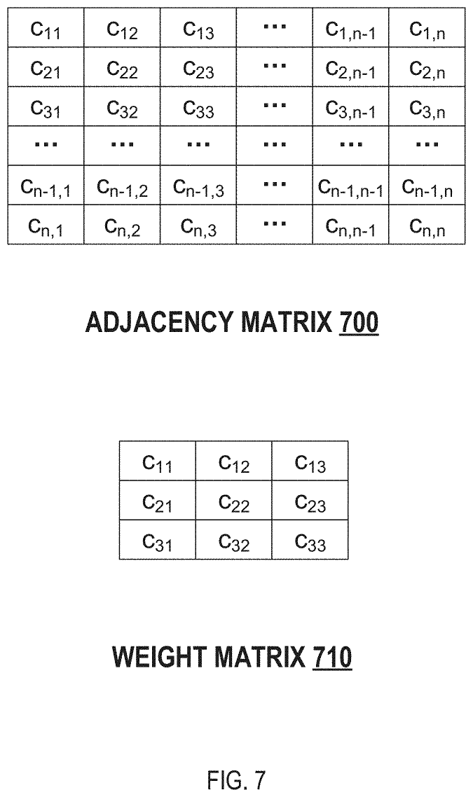

As a particular example, as will be described in more detail below with reference to FIG. 7, the architecture of the brain emulation neural network layer, included in any of the components of the system 100 (e.g., in the encoder block 111A), can be represented by a weight matrix. The brain emulation neural network layer can apply the weight matrix (e.g., perform a matrix multiplication with the weight matrix) to a brain emulation layer input, to generate a corresponding brain emulation layer output. Each element of the weight matrix can be a respective brain emulation parameter of the brain emulation neural network layer. Example encoder blocks that include brain emulation neural network layers will be described in more detail below with reference to FIG. 3.

The brains of biological organisms may be adapted by evolutionary pressures to be effective at solving certain tasks, e.g., classifying objects or generating robust object representations, and attention-based brain emulation neural networks may share this capacity to effectively solve tasks. In particular, compared to other attention-based neural networks, e.g., with manually specified neural network architectures, attention-based brain emulation neural networks may require less training data, fewer training iterations, or both, to perform attention operations and solve certain tasks. Moreover, attention-based brain emulation neural networks may perform certain machine learning tasks more effectively, e.g., with higher accuracy, than other neural networks.

For example, in contrast to many conventional computer vision techniques, a biological brain may process visual data to generate a robust representation of the visual data that may be insensitive to factors such as the orientation and size of elements (e.g., objects) characterized by the visual data. The attention-based brain emulation neural network may also be effective at solving these (and other) tasks as a result of having elements in the architecture that match the biological brain. Because the attention-based brain emulation neural network can be more effective at performing certain machine learning tasks, it can significantly reduce the amount of training data and the number of training iterations required to train the neural network when compared to other, e.g., hand-engineered, attention-based neural networks. The process of training the attention-based brain emulation neural network 130 will be described in more detail next.

The neural network computing system 100 can further include a training engine 140 that can train the attention-based brain emulation neural network 130.

In some implementations, the brain emulation parameters of one or more brain emulation neural network layers in the attention-based neural network 130 are untrained. Instead, the brain emulation parameters can be determined before training of the attention-based brain emulation neural network 130 based on, e.g., weight values of the edges in the synaptic connectivity graph 108. Optionally, the weight values of the edges in the synaptic connectivity graph 108 can be transformed (e.g., by additive random noise) before the weight values are used for specifying the brain emulation parameters. This procedure enables the attention-based brain emulation neural network 130 to take advantage of the information from the synaptic connectivity graph 108 encoded into the brain emulation parameter in performing prediction tasks.

Rather than training the entire attention-based neural network 130 from end-to-end, the training engine 140 can train only the model parameters of each of the encoder blocks 110 (e.g., parameters 101A and parameters 101N) and/or the model parameters of the decoder block (e.g., parameters 103), while leaving the brain emulation parameters of the brain emulation layers included in any of the components of the system 100 fixed during training. For example, if the encoder block 111A includes a brain emulation neural network layer having a set of brain emulation parameters, the training engine 140 can train the encoder block parameters 101A while leaving the brain emulation parameters of the brain emulation layer included in the encoder block 111A fixed during training.

The training engine 140 can train the attention-based neural network 130 on a set of training data over multiple training iterations. The training data can include a set of training examples, where each training example specifies: (i) a training network input, and (ii) a target network output that should be generated by the neural network 130 by processing the training network input. At each training iteration, the training engine 140 can sample a batch of training examples from the training data, and process the training inputs specified by the training examples using the neural network 130 to generate corresponding network outputs 135. In particular, for each training input, the neural network 130 processes the training input using the current model parameter values of each of the encoder blocks (e.g., parameters 101A and parameters 101N), and static brain emulation parameters of brain emulation neural network layers included in the encoder blocks 110, to generate a current embedding of the training input. The neural network 130 then processes the current embedding of the training input using the current model parameter values of the decoder block (e.g., parameters 103) and, optionally, static brain emulation parameters of brain emulation neural network layers included in the decoder block 120, to generate the network output 135 corresponding to the training input. The training engine 140 adjusts the model parameter values of the encoder blocks 110 and the model parameter values of the decoder block 120 to optimize an objective function that measures a similarity between: (i) the network outputs 135 generated by the neural network 130, and (ii) the target network outputs specified by the training examples. The objective function can be, e.g., a cross-entropy objective function, a squared-error objective function, or any other appropriate objective function.

To optimize the objective function, the training engine 140 can determine gradients of the objective function with respect to the model parameters of the encoder blocks 110 (e.g., parameters 101A and 101N) and the model parameters of the decoder block 120 (e.g., parameters 103), e.g., using backpropagation techniques. The training engine 140 can then use the gradients to adjust the model parameter values of the encoder blocks 110 and the decoder block 120, e.g., using any appropriate gradient descent optimization technique, e.g., an RMSprop or Adam gradient descent optimization technique.

The training engine 140 can use any of a variety of regularization techniques during training of the attention-based brain emulation neural network 130. For example, the training engine 140 can use a dropout regularization technique, such that certain artificial neurons of the neural network 130 are “dropped out” (e.g., by having their output set to zero) with a non-zero probability p>0 each time the neural network 130 processes a network input. Using the dropout regularization technique can improve the performance of the trained attention-based neural network 130, e.g., by reducing the likelihood of over-fitting. As another example, the training engine 140 can regularize the training of the neural network 130 by including a “penalty” term in the objective function that measures the magnitude of the model parameter values of the encoder blocks 110 and the decoder block 120. The penalty term can be, e.g., an L1 or L2 norm of the model parameter values of the encoder blocks and/or the decoder block 120.

In some implementations, the brain emulation parameters of one or more brain emulation neural network layers included in the attention-based brain emulation neural network 130 are trained. That is, after initial values for the brain emulation parameters have been determined based on the weight values of the edges in the synaptic connectivity graph 108, the training engine 140 can update the weights of the brain emulation parameters, as described above with reference to the encoder parameters (e.g., parameters 101A, 101N) and decoder parameters (e.g., parameters 103), e.g., using backpropagation and stochastic gradient descent. Example encoder block (e.g., 111A) included in the attention-based brain emulation neural network 130 will be described in more detail below with reference to FIG. 2.

After training, the attention-based brain emulation neural network 130 can be used to perform the machine learning task. Generally, the neural network 130 can be configured to perform any appropriate task. A few examples follow.

In one example, the neural network 130 can be configured to process network inputs 115 that represent sequences of audio data. For example, each input element in the network input 115 can be a raw audio sample or an input generated from a raw audio sample (e.g., a spectrogram), and the neural network 130 can process the sequence of input elements to generate network outputs 135 representing predicted text samples that correspond to the audio samples. That is, the neural network 130 can be a “speech-to-text” neural network. As another example, each input element can be a raw audio sample or an input generated from a raw audio sample, and the neural network 130 can generate a predicted class of the audio samples, e.g., a predicted identification of a speaker corresponding to the audio samples.

As a particular example, the predicted class of the audio sample can represent a prediction of whether the input audio example is a verbalization of a predefined work or phrase, e.g., a “wakeup” phrase of a mobile device. In some implementations, one or more weight matrices of the brain emulation neural network layers (e.g., included in one or more encoder blocks 110) can be generated from a sub-graph of the synaptic connectivity graph corresponding to an audio region of the brain, i.e., a region of the brain that processes auditory information (e.g., the auditory cortex).

In another example, the neural network 130 can be configured to process network inputs 115 that represent sequences of text data. For example, each input element in the network input 115 can be a text sample (e.g., a character, phoneme, or word) or an embedding of a text sample, and the neural network 130 can process the sequence of input elements to generate network outputs 135 representing predicted audio samples that correspond to the text samples. That is, the neural network 130 can be a “text-to-speech” neural network. As another example, each input element can be an input text sample or an embedding of an input text sample, and the neural network 130 can generate a network output 135 representing a sequence of output text samples corresponding to the sequences of input text samples. As a particular example, the output text samples can represent the same text as the input text samples in a different language (i.e., the neural network 130 can be a machine translation neural network).

As another particular example, the output text samples can represent an answer to a question posed by the input text samples (i.e., the neural network 130 can be a question-answering neural network). As another example, the input text samples can represent two texts (e.g., as separated by a delimiter token), and the neural network 130 can generate a network output representing a predicted similarity between the two texts. In some implementations, one or more weight matrices of the brain emulation neural network layers (e.g., included in one or more encoder blocks 110) can be generated from a sub-graph of the synaptic connectivity graph 108 corresponding to a speech region of the brain, i.e., a region of the brain that is linked to speech production (e.g., Broca's area).

In another example, the neural network 130 can be configured to process network inputs 115 representing one or more images, e.g., sequences of video frames. For example, each input element in the network input 115 can be a video frame or an embedding of a video frame, and the neural network 130 can process the sequence of input elements to generate a network output 214 representing a prediction about the video represented by the sequence of video frames. As a particular example, the neural network 130 can be configured to track a particular object in each of the frames of the video, i.e., to generate a network output 135 that includes a sequences of output elements, where each output element represents a predicted location within a respective video frames of the particular object. In some implementations, the brain emulation neural network layers (e.g., included in one or more encoder blocks 110) can be generated from a sub-graph of the synaptic connectivity graph 108 corresponding to a visual region of the brain, i.e., a region of the brain that processes visual information (e.g., the visual cortex).

In another example, the neural network 130 can be configured to process a network input 115 representing a respective current state of an environment at each of one or more time points, and to generate a network output 135 representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

Example encoder blocks 110 that can be included in the attention-based brain emulation neural network 130 will be described in more detail next.

FIG. 2 is a block diagram of an example encoder block 200 (e.g., the encoder block 111A in FIG. 1) included in an attention-based brain emulation neural network (e.g., the network 130 in FIG. 1). The encoder block 200 is an example of a system implemented as computer programs on one or more computers in one or more locations in which the systems, components, and techniques described below are implemented.

The encoder block 200 can receive a current embedding of a network input 225 (e.g., an embedding of each respective data element for each input position in a sequence of input positions) and process the current embeddings 225 to generate an updated embedding of the network input 235 (e.g., an updated embedding of each respective data element for each input position in the sequence of input positions). As described above with reference to FIG. 1, the attention-based brain emulation neural network can generally include a sequence of encoder blocks, e.g., multiple encoder blocks 200 arranged in a sequence. In some implementations, the current embedding of the network input 225 that is received by the first encoder block in the sequence of encoder blocks can be generated by an embedding layer in the attention-based brain emulation neural network that precedes the first encoder block, e.g., as described above with reference to FIG. 1.

After the first encoder block in the sequence processes the current embedding of the network input 225 and generates the updated embedding of the network input 235, the updated embedding of the network input 235 can be provided to the next encoder block in the sequence of encoder blocks as an input.

The encoder block 200 can process the input 225 to generate the output 235 by using: (i) an attention module 220 and (ii) a feed forward module 230, each of which will be described in more detail next.

The attention module 220 can include an attention sub-network 250 that is configured to perform an attention operation, e.g., to receive the current embedding of the network input 225 for each input position in the sequence of input positions and, for each particular input position, apply the attention operation over the current embeddings 225 at the input positions, using one or more queries derived from the current embeddings 225 at the particular input position, to generate a respective updated embedding for the particular input position.

In particular, the attention sub-network 250 is configured to map a query and a set of key-value pairs to an output, where the query, keys, and values are all vectors. The output is computed as a weighted sum of the values, where the weight assigned to each value is computed by a compatibility function of the query with the corresponding key. Example attention operation is described in more detail with reference to: Vaswani, Ashish, Noam Shazeer, Niki Parmar, Jakob Uszkoreit, Llion Jones, Aidan N. Gomez, Lukasz Kaiser, and Illia Polosukhin. “Attention is all you need,” In Advances in neural information processing systems, pp. 5998-6008, 2017, which is incorporated by reference herein in its entirety.

Specifically, in some implementations, the attention sub-network 250 can include: (i) a query sub-network, (ii) a key sub-network, and (iii) a value sub-network. Some, or all, of the query sub-network, key sub-network, and value sub-network, can include one or more brain emulation neural network layers. The brain emulation neural network layers can have brain emulation parameters that, when initialized, can represent biological connectivity between biological neuronal elements in the brain of a biological organism. Some, or all, of the sub-networks can use the one or more brain emulation layers, and the brain emulation parameters, to perform the operations described below.

The query sub-network can be configured to process the input 225 (e.g., the embedding for each input position in the sequence of input positions) and generate a respective query vector for each input position. Similarly, the key sub-network can be configured to process the input 225 (e.g., the embedding for each input position in the sequence of input positions) and generate a respective key vector for each input position. Further, the value sub-network can be configured to process the input 225 (e.g., the embedding for each input position in the sequence of input positions) and generate a respective value vector for each input position. The attention sub-network 250 can use the query vectors, the key vectors, and the value vectors, to perform the attention operation.

In some implementations, the attention sub-network 250 can perform a scaled dot-product attention operation for each input position in the sequence of input positions by determining a respective input-position specific weight for each input position, e.g., by applying a compatibility function between the query vector for the input position and the key vectors, and computing an updated current embedding for the input position by determining a weighted sum of the value vectors weighted by the corresponding input-position specific weights for the input positions.

For example, for a given query vector, the attention sub-network 250 can determine the dot product of the query vector which each of the key vectors, divide each of the dot products by a scaling factor, e.g., by the square root of the dimensions of the query vectors and key vectors, and then apply a softmax function over the scaled dot products to obtain weights on the values (e.g., input-position specific weights). The attention sub-network 250 can then determine a weighted sum of the value vectors in accordance with these weights. For the scaled dot-product attention operation, the compatibility function is the dot product and the output of the compatibility function is further scaled by the scaling factor.

As another example, the attention sub-network 250 can combine all query vectors into a query matrix Q, all key vectors into a key matrix K, and all value vectors into a value matrix V. For example, each row of the query matrix Q can be a respective query vector. The attention sub-network 250 can perform a matrix multiplication between the query matrix Q and the transpose of the key matrix K to generate a compatibility matrix, e.g., a matrix of compatibility function outputs. The attention sub-network 250 can scale the compatibility matrix by a scaling factor, e.g., divide each element of the compatibility matrix by the square root of the dimensions of the query vectors and key vectors.

After scaling the compatibility matrix, the attention sub-network 250 can apply a softmax function to the compatibility matrix to generate a weighting matrix. Lastly, the attention sub-network 250 can perform a matrix multiplication between the weighting matrix and the value matrix V to generate the attention output 245, e.g., an output matrix that includes the output of the attention sub-network 250 for each of the value vectors. In some implementations,

In some implementations, the attention module 220 further includes a residual connection (e.g., indicated by a dashed arrow in FIG. 2) and an Add & Norm layer that combine the output from the attention sub-network 250 with the input into the attention sub-network 250 and apply layer normalization to the combination to generate the attention output 245.

The feed forward module 230 can be a neural network that is configured to operate on each embedding for each input position in the sequence of input positions separately (e.g., independently). The feed forward module 230 can be configured to receive the attention output 245 from the attention module 220 and process it to generate the updated embedding of the network input 235. As a particular example, the feed forward module 230 can include a feed forward sub-network 260. Similarly to the attention sub-network 250 described above, the feed forward sub-network 260 can also include one or more brain emulation neural network layers having brain emulation parameters that, when initialized, can represent biological connectivity between biological neuronal elements in the brain of a biological organism. The feed forward sub-network 260 can use the brain emulation parameters to perform the operations described below.

The feed forward sub-network 260 can be configured to receive an input for each input position in the sequence of input positions and apply a sequence of transformations to the input at each input position to generate an output for each input position. For example, the sequence of transformations can include two or more learned linear transformations each separated by an activation function, e.g., a non-linear elementwise activation function, e.g., a ReLU or a GeLU activation function, which can allow for faster and more effective training on large and complex datasets.

Similarly as described above with reference to the attention module 220, the feed forward module 230 can further include a residual connection (e.g., indicated by a dashed arrow in FIG. 2) and an Add & Norm layer that combine the output from the feed forward sub-network 260 with the input into the feed forward sub-network 260 and apply layer normalization to the combination to generate the updated embedding of the network input 235. The updated embedding of the network input 235 can be provided to the next encoder block 200 in the sequence as an input (e.g., as the current embedding of the network input 225).

As described above with reference to FIG. 1, the attention-based brain emulation neural network can include a sequence of encoder blocks. In some implementations, all encoder blocks in the sequence can have the same architecture, e.g., the architecture exemplified by the encoder block 200. In some implementations, some encoder blocks in the sequence can have different architectures. Generally, the above architecture of the encoder block 200 is provided for illustrative purposes only, and the encoder block 200 can have any appropriate architecture that enables it to perform its prescribed function, e.g., can include any number of attention sub-networks and/or layers, fully-connected layers, convolutional layers, recurrent layers, or any other appropriate neural network layers. In some implementations, some, or all, of the encoder blocks do not include any recurrent or convolutional neural network layers.

As described above with reference to FIG. 1, the attention-based brain emulation neural network can include one or more brain emulation neural network layers, e.g., neural network layers having brain emulation parameters that, when initialized, represent synaptic connectivity between biological neuronal elements in the brain of a biological organism. The one or more brain emulation neural network layers can be included in any position within the encoder block 200, e.g., in the feed forward module 230, or in the attention module 220, or in both the feed forward module 230 and the attention module 220.

As a further example, one or more brain emulation neural network layers can be included in the attention sub-network 250, or in the feed forward sub-network 260, or in both the attention sub-network 250 and the feed forward sub-network 260. As a particular example, one or more brain emulation neural network layers can be included in some, or all, of: (i) the query sub-network, (ii) the key sub-network, and (iii) the value sub-network, and can be used to perform the attention operation, as described above.

These examples are provided for illustrative purposes only, and brain emulation neural network layers can be included in any part of the attention based brain emulation neural network (e.g., the decoder block 120 in FIG. 1). Example encoder blocks (e.g., the encoder block 200) having brain emulation neural network layers will be described in more detail next.

FIG. 3 is a block diagram of example encoder blocks 300a, 300b (e.g., encoder block 200 in FIG. 2) included in an attention-based brain emulation neural network (e.g., the network 130 in FIG. 1). Each encoder block 300a, 300b is an example of a system implemented as computer programs on one or more computers in one or more locations in which the systems, components, and techniques described below are implemented.

As described above with reference to FIG. 2, each encoder block 300a, 300b can include: (i) an attention module 320, and (ii) a feed forward module, e.g., 330a or 330b. Each feed forward module 330a, 330b, in turn, can include a feed forward sub-network 335a, 335b, respectively, and one or more additional neuronal network layers, e.g., layer normalization layers. In the example encoder blocks 300a and 300b, illustrated in FIG. 3, each of the feed forward sub-networks 335a, 335b, includes a brain emulation neural network layer 350 having an architecture that is specified by synaptic connectivity between biological neuronal elements in the brain of a biological organism. In particular, the brain emulation neural network layers 350 can include brain emulation parameters that, when initialized, can represent connectivity between biological neuronal elements in the brain of the biological organism.

The encoder blocks 335a, 335b can include any number of brain emulation neural network layers that can be positioned anywhere within the encoder blocks 335a, 335b, e.g., within the attention module 320, and/or within the feed forward module 330a, 300b, as illustrated in FIG. 3.

Furthermore, the attention module 320 and the feed forward module 330a, 300b can have any appropriate neural network architectures that allow them to perform their prescribed functions, e.g., the functions described above with reference to FIG. 1 and FIG. 2.

In particular, as described above with reference to FIG. 1 and FIG. 2, the attention module 320 can be configured to process a current embedding of a network input to generate an attention output. The feed forward sub-network 335a can receive the attention output from the attention module 320 and process it to generate an updated current embedding of the network input. The updated embedding can be provided to the next encoder block in the sequence of encoder blocks in the attention-based brain emulation neural network as an input.

The feed forward sub-network 335a can be configured to operate on each input element at each input position in the sequence of input positions (e.g., in the attention output generated by the attention module 320) separately and identically. For example, the first layer in the feed forward sub-network 335a, e.g., the FF GeLU layer, can be configured to apply a non-linear activation function (e.g., Gaussian Error Linear Unit function, or any other appropriate function) to each input element in the sequence of input positions.

As will be described in more detail below with reference to FIG. 7, the architecture of the brain emulation neural network layer 350 can be represented by a weight matrix. The brain emulation neural network layer 350 can be configured to apply the weight matrix to the input into the brain emulation neural network layer 350 (e.g., the output from the FF GeLU layer). Generally “applying” a matrix can refer to, e.g., performing a multiplication with the matrix. Each element of the weight matrix can be a respective brain emulation parameter of the brain emulation neural network layer 350. The next layer in the feed forward sub-network 335a, e.g., the FF layer, can be configured to apply a linear transformation to the output from the brain emulation neural network layer 350.

The feed forward module 330a, 330b can further include a dropout neural network layer, e.g., Dropout in FIG. 3, that can be configured to implement a dropout regularization technique.

The feed forward module 330a, 330b can further include a residual connection (e.g., indicated by a dashed arrow in FIG. 3) that can combine the output from the dropout layer with the input into the feed forward sub-network 335a, 335b to generate a combined output. The last layer in the feed forward module 330a, 330b, e.g., LayerNorm in FIG. 3, can be configured to apply layer normalization to the combined output to generate the updated embedding of the network input. As described above, the updated embedding of the network input can be provided to the next encoder block in the sequence of encoder blocks as an input.

An example of processing a network input using a neural network that includes the example encoder blocks 300a, 300b, will be described in more detail next.

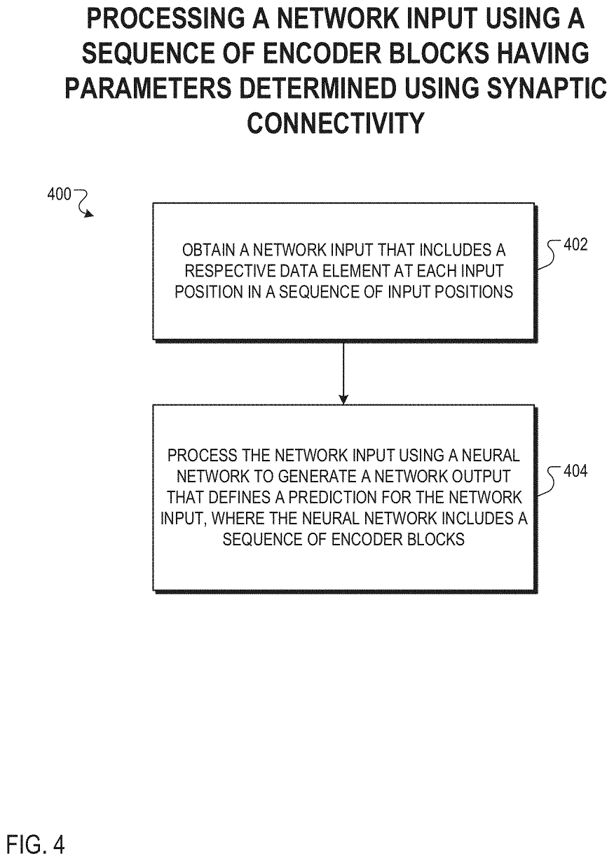

FIG. 4 is a flow diagram of an example process 400 for processing a network input using an attention-based brain emulation neural network. For convenience, the process 400 will be described as being performed by a system of one or more computers located in one or more locations, e.g., the attention-based brain emulation neural network 130 in FIG. 1.

The system obtains a network input including a respective data element at each input position in a sequence of input positions (402). The network input can include, for example, an image data type, a text data type, or an audio data type.

The system processes the network input using a neural network to generate a network output that defines a prediction related to the network input (404).

The neural network can include a sequence of encoder blocks and a decoder block. Each encoder block can have a respective set of encoder block parameters and can performs operations including: receiving a respective current embedding for each input position, and processing the current embeddings for the input positions, in accordance with the set of encoder block parameters, to update the respective current embedding for each input position, which can include applying an attention operation to the current embeddings for the input positions. The set of encoder block parameters can include multiple brain emulation parameters that, when initialized, represent biological connectivity between biological neuronal elements in the brain of a biological organism.

In some implementations, at least one encoder block in the sequence of encoder blocks includes a feed forward module. The feed forward module can include, e.g., one or more brain emulation neural network layers having brain emulation parameters that, when initialized, represent biological connectivity between biological neuronal elements in the brain of the biological organism. For each input position in the sequence of input positions, the feed forward module can receive an input at the input position, and apply a sequence of transformations to the input at the input position using the one or more brain emulation neural network layers to generate an output for the input position.

In some implementations, at least one encoder block in the sequence of encoder blocks includes an attention module that includes: (i) a query sub-network configured to process the respective current embedding for each input position to generate a query vector, (ii) a key sub-network configured to process the respective current embedding for each input position to generate a key vector, and (iii) a value sub-network configured to process the respective current embedding for each input position to generate a value vector. Some, or all, of the query sub-network, the key sub-network, and the value sub-network, can include one or more brain emulation neural network layers having brain emulation parameters that, when initialized, represent biological connectivity between biological neuronal elements in the brain of the biological organism.

The attention module can perform the attention operation. For example, for each input position in the sequence of input positions, the attention module can process the respective current embedding for the input position using one or more brain emulation neural network layers included in the query sub-network to generate a query vector, process the respective current embedding for the input position using one or more brain emulation neural network layers included in the key sub-network to generate a key vector, and process the respective current embedding for the input position using one or more brain emulation neural network layers included in the value sub-network to generate a value vector. The attention module can further determine a respective input-position specific weight for each of input position by applying a compatibility function between the query vector for the input position and the key vectors, and determine the updated current embedding for the input position by determining a weighted sum of the value vectors weighted by the corresponding input-position specific weights for the input positions.

The decoder block can have a set of decoder block parameters and can performs operations including: receiving the respective current embedding for each input position from a final encoder block in the sequence of encoder blocks, and processing the current embeddings for the input positions, in accordance with the set of decoder block parameters, to generate the network output. In some implementations, the set of decoder block parameters can include brain emulation parameters that, when initialized, represent biological connectivity between biological neuronal elements in the brain of the biological organism.

An example process for generating a brain emulation neural network architecture, e.g., the architecture of one or more brain emulation neural network layers having brain emulation parameters that, when initialized, represent biological connectivity between biological neuronal elements in the brain of the biological organism, will be described in more detail next.

FIG. 5 is an example data flow 500 for generating a brain emulation neural network architecture 560 using a synaptic connectivity graph 530. A synaptic resolution image of the brain 515 of a biological organism 510, e.g., a fly can be processed to generate the synaptic connectivity graph 530, e.g., where each node in the graph 530 corresponds to a neuronal element in the brain 510, and two nodes in the graph 530 are connected if the corresponding neuronal elements in the brain 515 share a synaptic connection. An architecture mapping system 540 540 can use the structure of the graph 530 to specify the brain emulation neural network architecture 560. For example, each node in the graph 530 can be mapped to an artificial neuron, a neural network layer, or a group of neural network layers in the brain emulation neural network architecture 560.

Further, each edge of the graph 530 can be mapped to a connection between artificial neurons, layers, or groups of layers in the brain emulation neural network architecture 560. The brain 515 of the biological organism 510 can be adapted by evolutionary pressures to be effective at solving certain tasks, e.g., classifying objects or generating robust object representations, and a neural network having the brain emulation neural network architecture 560 can share this capacity to effectively solve tasks. Example architecture mapping system 540 will be described in more detail next

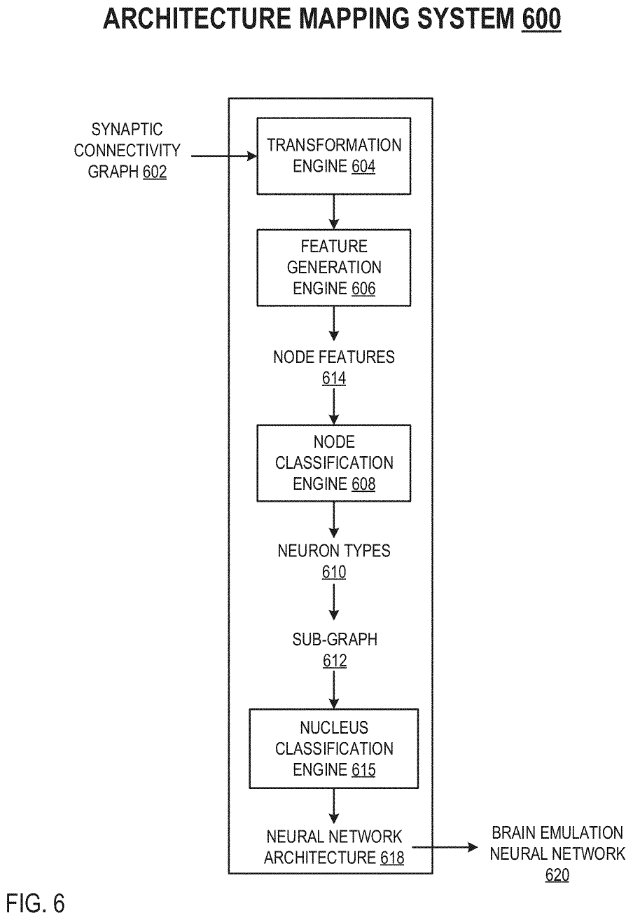

FIG. 6 is a block diagram of an example architecture mapping system 600. The architecture mapping system 600 is an example of a system implemented as computer programs on one or more computers in one or more locations in which the systems, components, and techniques described below are implemented.

The architecture mapping system 600 is configured to process a synaptic connectivity graph 602 (e.g., the synaptic connectivity graph 530 in FIG. 5) to determine a corresponding neural network architecture 618 of a brain emulation neural network 620 (e.g., the brain emulation neural network architecture 560 in FIG. 5). The architecture mapping system 600 can determine the architecture 618 using one or more of: a transformation engine 604, a feature generation engine 606, a node classification engine 608, and a nucleus classification engine 615, which will each be described in more detail next.

The transformation engine 604 can be configured to apply one or more transformation operations to the synaptic connectivity graph 602 that alter the connectivity of the graph 602, i.e., by adding or removing edges from the graph. A few examples of transformation operations follow.

In one example, to apply a transformation operation to the graph 602, the transformation engine 604 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 604 can modify the connectivity between the two nodes in the node pair with a predefined probability (e.g., 0.1%). In one example, the transformation engine 604 can connect the nodes by an edge (i.e., if they are not already connected by an edge) with the predefined probability. In another example, the transformation engine 604 can reverse the direction of any edge connecting the two nodes with the predefined probability. In another example, the transformation engine 604 can invert the connectivity between the two nodes with the predefined probability, i.e., by adding an edge between the nodes if they are not already connected, and by removing the edge between the nodes if they are already connected.

In another example, the transformation engine 604 can apply a convolutional filter to a representation of the graph 602 as a two-dimensional array of numerical values. As described above, the graph 602 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 604 can quantize the values in the array representing the graph, e.g., by rounding each value in the array to 0 or 1, to cause the array to unambiguously specify the connectivity of the graph. Applying a convolutional filter to the representation of the graph 602 can have the effect of regularizing the graph, e.g., by smoothing the values in the array representing the graph to reduce the likelihood of a component in the array having a different value than many of its neighbors.

In some cases, the graph 602 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The architecture mapping system 600 can use the feature generation engine 606 and the node classification engine 608 to determine predicted “types” 610 of the neuronal elements corresponding to the nodes in the graph 602. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information. After identifying the types of the neuronal elements corresponding to the nodes in the graph 602, the architecture mapping system 600 can identify a sub-graph 612 of the overall graph 602 based on the neuron types, and determine the neural network architecture 618 based on the sub-graph 612. The feature generation engine 606 and the node classification engine 608 are described in more detail next.

The feature generation engine 606 can be configured to process the graph 602 (potentially after it has been modified by the transformation engine 604) to generate one or more respective node features 614 corresponding to each node of the graph 602. The node features corresponding to a node can characterize the topology (i.e., connectivity) of the graph relative to the node. In one example, the feature generation engine 606 can generate a node degree feature for each node in the graph 602, where the node degree feature for a given node specifies the number of other nodes that are connected to the given node by an edge. In another example, the feature generation engine 606 can generate a path length feature for each node in the graph 602, where the path length feature for a node specifies the length of the longest path in the graph starting from the node.

A path in the graph may refer to a sequence of nodes in the graph, such that each node in the path is connected by an edge to the next node in the path. The length of a path in the graph may refer to the number of nodes in the path. In another example, the feature generation engine 606 can generate a neighborhood size feature for each node in the graph 602, where the neighborhood size feature for a given node specifies the number of other nodes that are connected to the node by a path of length at most N. In this example, N can be a positive integer value. In another example, the feature generation engine 606 can generate an information flow feature for each node in the graph 602. The information flow feature for a given node can specify the fraction of the edges connected to the given node that are outgoing edges, i.e., the fraction of edges connected to the given node that point from the given node to a different node.

In some implementations, the feature generation engine 606 can generate one or more node features that do not directly characterize the topology of the graph relative to the nodes. In one example, the feature generation engine 606 can generate a spatial position feature for each node in the graph 602, where the spatial position feature for a given node specifies the spatial position in the brain of the neuron corresponding to the node, e.g., in a Cartesian coordinate system of the synaptic resolution image of the brain. In another example, the feature generation engine 606 can generate a feature for each node in the graph 602 indicating whether the corresponding neuron is excitatory or inhibitory. In another example, the feature generation engine 606 can generate a feature for each node in the graph 602 that identifies the neuropil region associated with the neuron corresponding to the node.

In some cases, the feature generation engine 606 can use weights associated with the edges in the graph in determining the node features 614. As described above, a weight value for an edge connecting two nodes can be determined, e.g., based on the area of any overlap between tolerance regions around the neurons corresponding to the nodes. In one example, the feature generation engine 606 can determine the node degree feature for a given node as a sum of the weights corresponding to the edges that connect the given node to other nodes in the graph. In another example, the feature generation engine 606 can determine the path length feature for a given node as a sum of the edge weights along the longest path in the graph starting from the node.

The node classification engine 608 can be configured to process the node features 614 to identify a predicted neuron type 610 corresponding to certain nodes of the graph 602. In one example, the node classification engine 608 can process the node features 614 to identify a proper subset of the nodes in the graph 602 with the highest values of the path length feature. For example, the node classification engine 608 can identify the nodes with a path length feature value greater than the 90th percentile (or any other appropriate percentile) of the path length feature values of all the nodes in the graph. The node classification engine 608 can then associate the identified nodes having the highest values of the path length feature with the predicted neuron type of “primary sensory neuron.”

In another example, the node classification engine 608 can process the node features 614 to identify a proper subset of the nodes in the graph 602 with the highest values of the information flow feature, i.e., indicating that many of the edges connected to the node are outgoing edges. The node classification engine 608 can then associate the identified nodes having the highest values of the information flow feature with the predicted neuron type of “sensory neuron.” In another example, the node classification engine 608 can process the node features 614 to identify a proper subset of the nodes in the graph 602 with the lowest values of the information flow feature, i.e., indicating that many of the edges connected to the node are incoming edges (i.e., edges that point towards the node). The node classification engine 608 can then associate the identified nodes having the lowest values of the information flow feature with the predicted neuron type of “associative neuron.”

The architecture mapping system 600 can identify a sub-graph 612 of the overall graph 602 based on the predicted neuron types 610 corresponding to the nodes of the graph 602. A “sub-graph” may refer to a graph specified by: (i) a proper subset of the nodes of the graph 602, and (ii) a proper subset of the edges of the graph 602. In one example, the architecture mapping system 600 can select: (i) each node in the graph 602 corresponding to particular neuronal element type, and (ii) each edge in the graph 602 that connects nodes in the graph corresponding to the particular neuronal element type, for inclusion in the sub-graph 612. The neuronal element type selected for inclusion in the sub-graph can be, e.g., visual neurons, olfactory neurons, memory neurons, or any other appropriate type of neuronal elements. In some cases, the architecture mapping system 600 can select multiple neuronal element types for inclusion in the sub-graph 612, e.g., both visual neurons and olfactory neurons.

The type of neuronal element selected for inclusion in the sub-graph 612 can be determined based on the task which the brain emulation neural network 620 will be configured to perform. In one example, the brain emulation neural network 620 can be configured to perform an image processing task, and neuronal elements that are predicted to perform visual functions (i.e., by processing visual data) can be selected for inclusion in the sub-graph 612. In another example, the brain emulation neural network 620 can be configured to perform an odor processing task, and neuronal elements that are predicted to perform odor processing functions (i.e., by processing odor data) can be selected for inclusion in the sub-graph 612. In another example, the brain emulation neural network 620 can be configured to perform an audio processing task, and neuronal elements that are predicted to perform audio processing (i.e., by processing audio data) can be selected for inclusion in the sub-graph 612.

If the edges of the graph 602 are associated with weight values (as described above), then each edge of the sub-graph 612 can be associated with the weight value of the corresponding edge in the graph 602. The sub-graph 612 can be represented, e.g., as a two-dimensional array of numerical values, as described with reference to the graph 602.

Determining the architecture 618 of the brain emulation neural network 620 based on the sub-graph 612 rather than the overall graph 602 can result in the architecture 618 having a reduced complexity, e.g., because the sub-graph 612 has fewer nodes, fewer edges, or both than the graph 602. Reducing the complexity of the architecture 618 can reduce consumption of computational resources (e.g., memory and computing power) by the brain emulation neural network 620, e.g., enabling the brain emulation neural network 620 to be deployed in resource-constrained environments, e.g., mobile devices. Reducing the complexity of the architecture 618 can also facilitate training of the brain emulation neural network 620, e.g., by reducing the amount of training data required to train the brain emulation neural network 620 to achieve an threshold level of performance (e.g., prediction accuracy).

In some cases, the architecture mapping system 600 can further reduce the complexity of the architecture 618 using a nucleus classification engine 615. In particular, the architecture mapping system 600 can process the sub-graph 612 using the nucleus classification engine 615 prior to determining the architecture 618. The nucleus classification engine 615 can be configured to process a representation of the sub-graph 612 as a two-dimensional array of numerical values (as described above) to identify one or more “clusters” in the array.

A cluster in the array representing the sub-graph 612 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 615 can identify contiguous regions of the array such that at least a threshold fraction of the components in the region have the value 1. The nucleus classification engine 615 can identify clusters in the array representing the sub-graph 612 by processing the array using a blob detection algorithm, e.g., by convolving the array with a Gaussian kernel and then applying the Laplacian operator to the array. After applying the Laplacian operator, the nucleus classification engine 615 can identify each component of the array having a value that satisfies a predefined threshold as being included in a cluster.

Each of the clusters identified in the array representing the sub-graph 612 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 615 identifies the clusters in the array representing the sub-graph 612, the architecture mapping system 600 can select one or more of the clusters for inclusion in the sub-graph 612. The architecture mapping system 600 can select the clusters for inclusion in the sub-graph 612 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 600 can select a predefined number of largest clusters (i.e., that include the greatest number of edges) for inclusion in the sub-graph 612.

The architecture mapping system 600 can reduce the sub-graph 612 by removing any edge in the sub-graph 612 that is not included in one of the selected clusters, and then map the reduced sub-graph 612 to a corresponding neural network architecture, as will be described in more detail below. Reducing the sub-graph 612 by restricting it to include only edges that are included in selected clusters can further reduce the complexity of the architecture 618, thereby reducing computational resource consumption by the brain emulation neural network 620 and facilitating training of the brain emulation neural network 620. The architecture mapping system 600 can determine the architecture 618 of the brain emulation neural network 620 from the sub-graph 612 in any of a variety of ways. For example, the architecture mapping system 600 can map each node in the sub-graph 612 to a corresponding: (i) artificial neuron, (ii) artificial neural network layer, or (iii) group of artificial neural network layers in the architecture 618, as will be described in more detail next.

In one example, the neural network architecture 618 can include: (i) a respective artificial neuron corresponding to each node in the sub-graph 612, and (ii) a respective connection corresponding to each edge in the sub-graph 612. In this example, the sub-graph 612 can be a directed graph, and an edge that points from a first node to a second node in the sub-graph 612 can specify a connection pointing from a corresponding first artificial neuron to a corresponding second artificial neuron in the architecture 618. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph.

An artificial neuron may refer to a component of the architecture 618 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 612 can be an undirected graph, and the architecture mapping system 600 can map an edge that connects a first node to a second node in the sub-graph 612 to two connections between a corresponding first artificial neuron and a corresponding second artificial neuron in the architecture. In particular, the architecture mapping system 600 can map the edge to: (i) a first connection pointing from the first artificial neuron to the second artificial neuron, and (ii) a second connection pointing from the second artificial neuron to the first artificial neuron.

In another example, the sub-graph 612 can be an undirected graph, and the architecture mapping system can map an edge that connects a first node to a second node in the sub-graph 612 to one connection between a corresponding first artificial neuron and a corresponding second artificial neuron in the architecture. The architecture mapping system 600 can determine the direction of the connection between the first artificial neuron and the second artificial neuron, e.g., by randomly sampling the direction in accordance with a probability distribution over the set of two possible directions. In some cases, the edges in the sub-graph 612 are not associated with weight values, and the weight values corresponding to the connections in the architecture 618 can be determined randomly. For example, the weight value corresponding to each connection in the architecture 618 can be randomly sampled from a predetermined probability distribution, e.g., a standard Normal (N(0,1)) probability distribution.

In another example, the neural network architecture 618 can include: (i) a respective artificial neural network layer corresponding to each node in the sub-graph 612, and (ii) a respective connection corresponding to each edge in the sub-graph 612. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values).

In one example, the architecture 618 can include a respective convolutional neural network layer corresponding to each node in the sub-graph 612, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ(i=1, . . . , n) is a tensor (e.g., a two- or three- dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ} (·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 600 can determine that the neural network architecture includes: (i) a respective group of artificial neural network layers corresponding to each node in the sub-graph 612, and (ii) a respective connection corresponding to each edge in the sub-graph 612. The layers in a group of artificial neural network layers corresponding to a node in the sub-graph 612 can be connected, e.g., as a linear sequence of layers, or in any other appropriate manner.

The neural network architecture 618 can include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 620. An output artificial neural neuron may refer to an artificial neuron that generates an output which is considered part of the overall output generated by the brain emulation neural network 620.

Various operations performed by the described architecture mapping system 600 are optional or can be implemented in a different order. For example, the architecture mapping system 600 can refrain from applying transformation operations to the graph 602 using the transformation engine 604, and refrain from extracting a sub-graph 612 from the graph 602 using the feature generation engine 606, the node classification engine 608, and the nucleus classification engine 615. In this example, the architecture mapping system 600 can directly map the graph 602 to the neural network architecture 618, e.g., by mapping each node in the graph to an artificial neuron and mapping each edge in the graph to a connection in the architecture, as described above.

FIG. 7 illustrates an example adjacency matrix 700 and an example weight matrix 710 of a brain emulation neural network determined using synaptic connectivity.

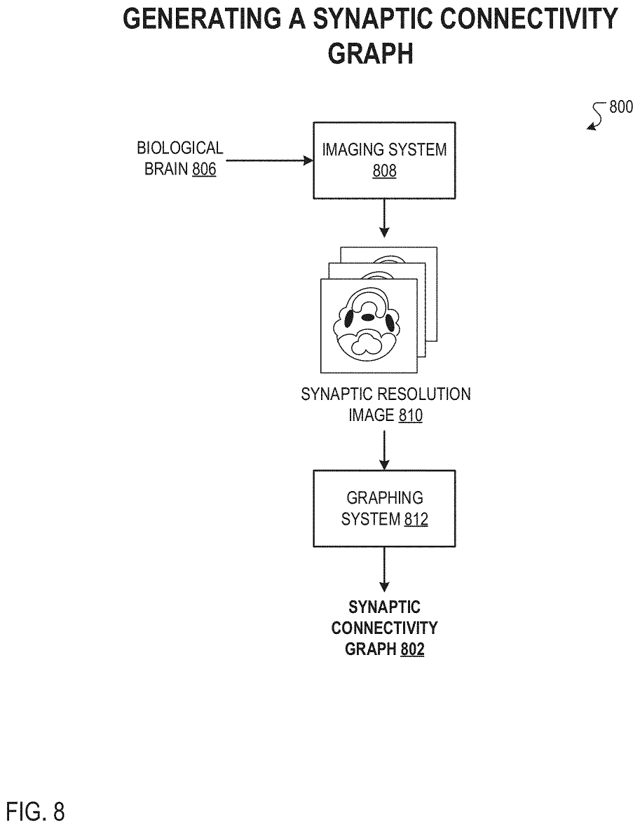

As described in more detail below with reference to FIG. 8, a graphing system (e.g., the graphing system 812 depicted in FIG. 8), can generate a synaptic connectivity graph that represents synaptic connectivity between biological neuronal elements in the brain of a biological organism. The synaptic connectivity graph can be represented using an adjacency matrix 700, all of which or a portion of which can be used as the weight matrix 710 of the brain emulation neural network.

As illustrated in FIG. 7, the adjacency matrix 700 includes n² elements, where n is the number of neuronal elements drawn from the brain of the biological organism. For example, the adjacency matrix 700 can include hundreds, thousands, tens of thousands, hundreds of thousands, millions, tens of millions, or hundreds of millions of elements.

Each element of the adjacency matrix 700 represents the synaptic connectivity between a respective pair of neurons in the set of n neurons. That is, each element c_{i,j} identifies the synaptic connection between neuronal element i and neuronal element j. In some implementations, each of the elements c_{i,j} are either zero (e.g., when there is no biological connection between the corresponding neuronal elements) or one (e.g., when there exists a biological connection between the corresponding neuronal elements), while in some other implementations, each element c_{i,j} is a scalar value representing the strength of the biological connection between the corresponding neuronal elements.

Each row of the adjacency matrix 700 can represent a respective neuronal element in a first set of neuronal elements in the brain of the biological organism, and each column of the adjacency matrix 700 can represent a respective neuronal element in a second set of neuronal elements in the brain of the biological organism. Generally, the first set and the second set can be overlapping or disjoint. As a particular example, the first set and the second set can be the same.

In some implementations (e.g., when the synaptic connectivity graph is a undirected graph), the adjacency matrix 700 is symmetric (i.e., each element c_{i,j} is the same as element c_{j,i}), while in some other implementations (e.g., in implementations in which the synaptic connectivity graph is directed), the adjacency matrix 700 is not symmetric (i.e., there may exist elements c_{i,j} and c_{j,i} such that c_{i,j}≠c_{j,i}).

Although the above description refers to neuronal elements in the brain of the biological organism, generally the elements of the adjacency matrix can correspond to pairs of any appropriate component of the brain of the biological organism. For example, each element can correspond to a pair of voxels in a voxel grid of the brain of the biological organism. As another example, each element can correspond to a pair of sub-neurons of the brain of the biological organism. As another example, each element can correspond to a pair of sets of multiple neurons of the brain of the biological organism.

As described in more detail above with reference to FIG. 6, an architecture mapping system 540 (e.g., the architecture mapping system 600 in FIG. 6) can generate the weight matrix 710 from the adjacency matrix 700. Generally, the elements of the weight matrix 710 (i.e., the brain emulation parameters of the brain emulation neural network) are a subset of the elements of the adjacency matrix 700. For example, as illustrated in FIG. 7, the weight matrix 710 includes the elements of the adjacency matrix 700 representing biological connections between the biological neuronal elements represented by the first three rows and first three columns of the adjacency matrix 700. In some implementations, the weight matrix 710 can represent neuronal elements only of a particular type. The process for identifying different types of neuronal elements is described above with reference to FIG. 6.

Although the weight matrix 710 is illustrated as having only nine brain emulation parameters, generally, weight matrices of brain emulation neural network layers can have significantly more brain emulation parameters, e.g., hundreds, thousands, or millions, of brain emulation parameters. Further, the weight matrix 710 can have any appropriate dimensionality.

In some implementations, the weight matrix 710 can represent the entire synaptic connectivity graph. That is, the weight matrix 710 can include a respective row and column for each node of the synaptic connectivity graph.

FIG. 8 is an example data flow 800 for generating a synaptic connectivity graph 802 based on the brain 806 of a biological organism.

An imaging system 808 can be used to generate a synaptic resolution image 810 of the brain 806. An image of the brain 806 may be referred to as having synaptic resolution if it has a spatial resolution that is sufficiently high to enable the identification of at least some synapses in the brain 806. Put another way, an image of the brain 806 may be referred to as having synaptic resolution if it depicts the brain 806 at a magnification level that is sufficiently high to enable the identification of at least some synapses in the brain 806. The image 810 can be a volumetric image, i.e., that characterizes a three-dimensional representation of the brain 806. The image 810 can be represented in any appropriate format, e.g., as a three-dimensional array of numerical values.

The imaging system 808 can be any appropriate system capable of generating synaptic resolution images, e.g., an electron microscopy system. The imaging system 808 can process “thin sections” from the brain 806 (i.e., thin slices of the brain attached to slides) to generate output images that each have a field of view corresponding to a proper subset of a thin section. The imaging system 808 can generate a complete image of each thin section by stitching together the images corresponding to different fields of view of the thin section using any appropriate image stitching technique.

The imaging system 808 can generate the volumetric image 810 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

In some implementations, the imaging system 808 can be a two-photon endomicroscopy system that utilizes a miniature lens implanted into the brain to perform fluorescence imaging.

This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 812 is configured to process the synaptic resolution image 810 to generate the synaptic connectivity graph 802. The synaptic connectivity graph 802 specifies a set of nodes and a set of edges, such that each edge connects two nodes. To generate the graph 802, the graphing system 812 identifies each neuronal element (e.g., a neuron, a group of neurons, or a portion of a neuron) in the image 810 as a respective node in the graph, and identifies each biological connection between a pair of neuronal elements in the image 810 as an edge between the corresponding pair of nodes in the graph.

The graphing system 812 can identify the neuronal elements and biological connections between neuronal elements depicted in the image 810 using any of a variety of techniques. For example, the graphing system 812 can process the image 810 to identify the positions of the neurons depicted in the image 810, and determine whether a biological connection exists between two neurons based on the proximity of the neurons (as will be described in more detail below).

In this example, the graphing system 812 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 812 can identify contiguous clusters of voxels in the neuron probability map as being neurons.

Optionally, prior to identifying the neurons from the neuron probability map, the graphing system 812 can apply one or more filtering operations to the neuron probability map, e.g., with a

Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 812 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 810 using neural networks (in particular, flood-filling neural networks) are described with reference to: P.H. Li et al.: “Automated Reconstruction of a Serial-Section EM Drosophila Brain with Flood-Filling Networks and Local Realignment,” bioRxiv doi:10.1101/605634 (2019).

The graphing system 812 can identify biological connections between neuronal elements in the image 810 based on the proximity of the neuronal elements. For example, the graphing system 812 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 812 can determine whether the first neuronal element and the second neuronal element are connected based on the number of spatial locations (e.g., voxels) that are included in both: (i) the tolerance region around the first neuronal element, and (ii) the tolerance region around the second neuronal element.

As a particular example, the graphing system 812 can determine that two neurons are connected if the overlap between the tolerance regions around the respective neurons includes at least a predefined number of spatial locations (e.g., one spatial location). A “tolerance region” around a neuronal element refers to a contiguous region of the image that includes the neuronal element. As a particular example, the tolerance region around a neuron can be specified as the set of spatial locations in the image that are either: (i) in the interior of the neuron, or (ii) within a predefined distance of the interior of the neuron.

The graphing system 812 can further identify a weight value associated with each edge in the graph 802. For example, the graphing system 812 can identify a weight for an edge connecting two nodes in the graph 802 based on the area of overlap between the tolerance regions around the respective neurons (or any other neuronal elements) corresponding to the nodes in the image 810 (e.g., based on a proximity of the respective neurons or other neuronal elements). The area of overlap can be measured, e.g., as the number of voxels in the image 810 that are contained in the overlap of the respective tolerance regions around the neurons. The weight for an edge connecting two nodes in the graph 802 may be understood as characterizing the (approximate) strength of the biological connection between the corresponding neuronal elements in the brain (e.g., the amount of information flow through the biological connection connecting the two neuronal elements).

In addition to identifying biological connections in the image 810, the graphing system 812 can further determine the direction of each biological connection using any appropriate technique. The “direction” of a biological connection between two neuronal elements refers to the direction of information flow between the two neuronal elements, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 812 determines the directions of the synapses in the image 810, the graphing system 812 can associate each edge in the graph 802 with the direction of the corresponding synapse. That is, the graph 802 can be a directed graph. In some other implementations, the graph 802 can be an undirected graph, i.e., where the edges in the graph are not associated with a direction.

The graph 802 can be represented in any of a variety of ways. For example, the graph 802 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 812 determines a weight value for each edge in the graph 802, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

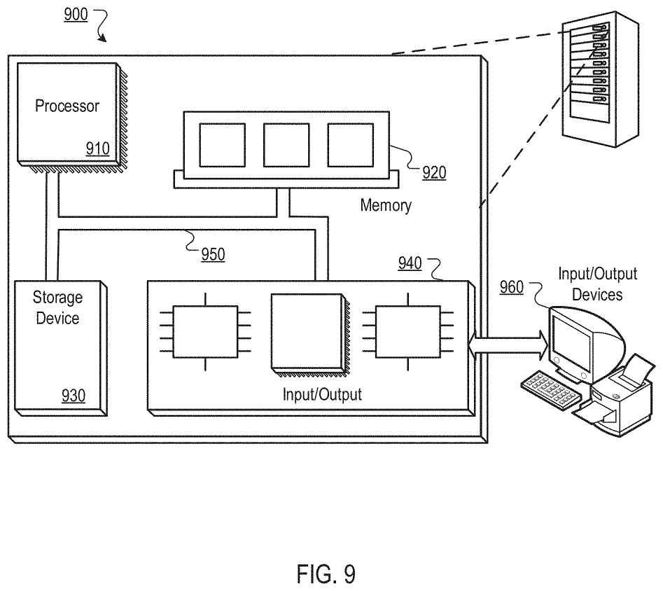

FIG. 9 is a block diagram of an example computer system 900 that can be used to perform operations described previously. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can include, for example, a hard disk device, an optical disk device, a storage device that is shared over a network by multiple computing devices (for example, a cloud storage device), or some other large capacity storage device.

The input/output device 940 provides input/output operations for the system 900. In one implementation, the input/output device 940 can include one or more network interface devices, for example, an Ethernet card, a serial communication device, for example, and RS-232 port, and/or a wireless interface device, for example, and 802.11 card. In another implementation, the input/output device 940 can include driver devices configured to receive input data and send output data to other input/output devices, for example, keyboard, printer and display devices 960. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
obtaining a network input comprising a respective data element at each input position in a sequence of input positions; and
processing the network input using a neural network to generate a network output that defines a prediction related to the network input,
wherein the neural network comprises a sequence of encoder blocks and a decoder block,
wherein each encoder block has a respective set of encoder block parameters and performs operations comprising:
receiving a respective current embedding for each input position;
processing the current embeddings for the input positions, in accordance with the set of encoder block parameters, to update the respective current embedding for each input position, comprising applying an attention operation to the current embeddings for the input positions;
wherein the set of encoder block parameters comprises a plurality of brain emulation parameters that, when initialized, represent biological connectivity between a plurality of biological neuronal elements in a brain of a biological organism;
wherein the decoder block has a set of decoder block parameters and performs operations comprising:
receiving the respective current embedding for each input position from a final encoder block in the sequence of encoder blocks; and
processing the current embeddings for the input positions, in accordance with the set of decoder block parameters, to generate the network output.

2. The method of claim 1, wherein at least one encoder block in the sequence of encoder blocks includes a feed forward module, and wherein the feed forward module includes one or more brain emulation neural network layers having the plurality of brain emulation parameters that, when initialized, represent biological connectivity between the plurality of biological neuronal elements in the brain of the biological organism.

3. The method of claim 2, wherein the feed forward module is configured to:
for each input position in the sequence of input positions:
receive an input at the input position; and
apply a sequence of transformations to the input at the input position using the one or more brain emulation neural network layers to generate an output for the input position.

4. The method of claim 1, wherein at least one encoder block in the sequence of encoder blocks includes an attention module that includes: (i) a query sub-network configured to process the respective current embedding for each input position to generate a query vector, (ii) a key sub-network configured to process the respective current embedding for each input position to generate a key vector, and (iii) a value sub-network configured to process the respective current embedding for each input position to generate a value vector.

5. The method of claim 4, wherein the query sub-network, the key sub-network, and the value sub-network, each include one or more brain emulation neural network layers having the plurality of brain emulation parameters that, when initialized, represent biological connectivity between the plurality of biological neuronal elements in the brain of the biological organism.

6. The method of claim 5, wherein the attention module is configured to perform the attention operation, and wherein the attention operation comprises, for each input position in the sequence of input positions:
processing the respective current embedding for the input position using the one or more brain emulation neural network layers included in the query sub-network to generate a query vector;
processing the respective current embedding for the input position using the one or more brain emulation neural network layers included in the key sub-network to generate a key vector;
processing the respective current embedding for the input position using the one or more brain emulation neural network layers included in the value sub-network to generate a value vector;
determining a respective input-position specific weight for each of the input positions by applying a compatibility function between the query vector for the input position and the key vectors; and
determining the updated current embedding for the input position by determining a weighted sum of the value vectors weighted by the corresponding input-position specific weights for the input positions.

7. The method of claim 1, wherein the set of decoder block parameters includes the plurality of brain emulation parameters that, when initialized, represent biological connectivity between the plurality of biological neuronal elements in the brain of the biological organism.

8. The method of claim 1, wherein a data type of the network input includes an image data type, a text data type, or an audio data type.

9. The method of claim 1, wherein the plurality of brain emulation parameters are determined from a synaptic connectivity graph that represents biological connectivity between the plurality of biological neuronal elements in the brain of the biological organism.

10. The method of claim 9, wherein the synaptic connectivity graph comprises a plurality of nodes and edges, each edge connects a pair of nodes, each node corresponds to a respective neuronal element in the brain of the biological organism, and each edge connecting a pair of nodes in the synaptic connectivity graph corresponds to a biological connection between a pair of biological neuronal elements in the brain of the biological organism.

11. The method of claim 1, wherein the plurality of brain emulation parameters are held static during training of the neural network.

12. The method of claim 1, wherein the plurality of brain emulation parameters are determined prior to training of the neural network based on weight values associated with biological connections between the plurality of biological neuronal elements in the brain of the biological organism.

13. The method of claim 1, wherein the plurality of brain emulation parameters are determined from a synaptic resolution image of at least a portion of the brain of the biological organism, the determining comprising:
processing the synaptic resolution image to identify: (i) the plurality of biological neuronal elements, and (ii) a plurality of biological connections between pairs of biological neuronal elements;
determining a respective value of each brain emulation parameter, comprising:
setting a value of each brain emulation parameter that corresponds to a pair of biological neuronal elements in the brain that are not connected by a biological connection to zero; and
setting a value of each brain emulation parameter that corresponds to a pair of biological neuronal elements in the brain that are connected by a biological connection based on a proximity of the pair of biological neuronal elements in the brain.

14. The method of claim 1, wherein each biological neuronal element of the plurality of biological neuronal elements is a biological neuron, a part of a biological neuron, or a group of biological neurons.

15. The method of claim 1, wherein the plurality of brain emulation parameters are arranged in a two-dimensional weight matrix having a plurality of rows and a plurality of columns,
wherein each row and each column of the weight matrix corresponds to a respective biological neuronal element from the plurality of biological neuronal elements, and
wherein each brain emulation parameter in the weight matrix corresponds to a respective pair of biological neuronal elements in the brain of the biological organism, the pair comprising:
(i) the biological neuronal element corresponding to a row of the brain emulation parameter in the weight matrix, and (ii) the biological neuronal element corresponding to a column of the brain emulation parameter in the weight matrix.

16. The method of claim 15, wherein initializing the plurality of brain emulation parameters comprises performing a matrix multiplication of: (i) the two-dimensional weight matrix of brain emulation parameters representing synaptic connectivity between the plurality of biological neuronal elements in the brain of the biological organism, and (ii) the current embeddings for the input positions.

17. The method of claim 15, wherein each brain emulation parameter of the weight matrix has a respective value that characterizes synaptic connectivity in the brain of the biological organism between the respective pair of biological neuronal elements corresponding to the brain emulation parameter.

18. The method of claim 17, wherein each brain emulation parameter of the weight matrix that corresponds to a respective pair of biological neuronal elements that are not connected by a biological connection in the brain of the biological organism has value zero, and each brain emulation parameter of the weight matrix that corresponds to a respective pair of biological neuronal elements that are connected by a biological connection in the brain of the biological organism has a respective non-zero value characterizing an estimated strength of the biological connection.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a network input comprising a respective data element at each input position in a sequence of input positions; and
processing the network input using a neural network to generate a network output that defines a prediction related to the network input,
wherein the neural network comprises a sequence of encoder blocks and a decoder block,
wherein each encoder block has a respective set of encoder block parameters and performs operations comprising:
receiving a respective current embedding for each input position;
processing the current embeddings for the input positions, in accordance with the set of encoder block parameters, to update the respective current embedding for each input position, comprising applying an attention operation to the current embeddings for the input positions;
wherein the set of encoder block parameters comprises a plurality of brain emulation parameters that, when initialized, represent biological connectivity between a plurality of biological neuronal elements in a brain of a biological organism;
wherein the decoder block has a set of decoder block parameters and performs operations comprising:
receiving the respective current embedding for each input position from a final encoder block in the sequence of encoder blocks; and
processing the current embeddings for the input positions, in accordance with the set of decoder block parameters, to generate the network output.

20. One or more non-transitory computer storage media storing instructions that when executed by one or more computers cause the one or more computers to perform operations comprising:
obtaining a network input comprising a respective data element at each input position in a sequence of input positions; and
processing the network input using a neural network to generate a network output that defines a prediction related to the network input,
wherein the neural network comprises a sequence of encoder blocks and a decoder block,
wherein each encoder block has a respective set of encoder block parameters and performs operations comprising:
receiving a respective current embedding for each input position;
processing the current embeddings for the input positions, in accordance with the set of encoder block parameters, to update the respective current embedding for each input position, comprising applying an attention operation to the current embeddings for the input positions;
wherein the set of encoder block parameters comprises a plurality of brain emulation parameters that, when initialized, represent biological connectivity between a plurality of biological neuronal elements in a brain of a biological organism;
wherein the decoder block has a set of decoder block parameters and performs operations comprising:
receiving the respective current embedding for each input position from a final encoder block in the sequence of encoder blocks; and
processing the current embeddings for the input positions, in accordance with the set of decoder block parameters, to generate the network output.
